(19) United States
(12) Patent Application Publication
(10) Pub. No.: US 2025/0065562 A1
(43) Pub. Date: Feb. 27, 2025

(54) METHOD AND APPARATUS FOR PRINTING A RETAINING WALL IN THE MANUFACTURE OF THREE-DIMENSIONAL OBJECTS

(71) Applicant: Desktop Metal, Inc., Burlington, MA (US)

(72) Inventors: Aaron PRESTON, Bedford, MA (US); Steve KILDAY, Marshfield, MA (US); Mark HEINZE, Shrewsbury, MA (US)

(21) Appl. No.: 18/792,640

(22) Filed: Aug. 2, 2024

Related U.S. Application Data
(60) Provisional application No. 63/530,802, filed on Aug. 4, 2023.

(51) Int. Cl. B29C 64/165; B22F 10/14; B22F 12/50; B22F 12/90; B29C 64/209; B29C 64/321; B29C 64/386; B33Y 10/00; B33Y 30/00; B33Y 50/02

(52) U.S. Cl. CPC B29C 64/165; B22F 10/14; B22F 12/50; B22F 12/90; B29C 64/209; B29C 64/321; B29C 64/386; B33Y 10/00; B33Y 30/00; B33Y 50/02

(57) ABSTRACT

Methods and apparatuses for making three-dimensional objects from a bindable powder are shown and described. A three-dimensional retaining wall is printed into the bindable powder to enclose the three-dimensional object and a volume of unsolidified bindable powder surrounding the three-dimensional object. In order to provide a more stable printed retaining wall, the wall is printed at less than one hundred percent image saturation and/or less than one hundred percent voxel saturation to increase the speed of solidification. One-hundred percent image saturation refers to solidifying all of the voxels (or pixels) that overlap the printed three-dimensional retaining wall, and one-hundred percent voxel saturation refers to an amount of binder per voxel that is printed to form the three-dimensional object that the printed three-dimensional retaining wall wholly or partially encloses.

### CROSS-REFERENCE TO RELATED APPLICATIONS

This is a non-provisional application under 35 USC § 111 that claims priority to U.S. Provisional Application 63/530,802, which was filed on Aug. 4, 2023, the entire contents of which are incorporated herein by reference.

### FIELD

The disclosure relates to a method and apparatus for making a three-dimensional object from a bindable powder and a binder using a printed retaining barrier, and more specifically, a printed retaining barrier that is solidified at a rate that reduces the likelihood of rupture of damage during a build process.

### DESCRIPTION OF THE RELATED ART

Three dimensional printers that use a powdered substrate are described for example, in U.S. Pat. Nos. 4,863,538; 5,147,587; 5,204,055; and 5,387,380. These machines operate through a cyclic sequence whereby a flowable powdered feed material is deposited by a spreading mechanism in a flat layer on a receiving surface; and subsequently a mechanism for selectively binding grains of powder is operated from above the receiving surface and bonds together a portion of the substrate into a thin layer in a pattern that coincides with a section of a solid object under construction. As a part of this cycle, one or more other optional mechanisms may be operated over the receiving surface, e.g., to color or otherwise modify the properties of the bonded layers. The cycle is repeated with an incremental motion that separates the spreading mechanism from the receiving surface, and a solid part is formed from the union of many layers that are bonded together.

The spreading mechanism may include a traveling powder dispenser, hopper, or dumper, and it may include a leveling device such as a sharp blade, a roller, or a blunt bar; any of which could be simply traveling in a line or vibrating during travel; and the roller could be driven by a motor in either direction, or it may be fixed or free-wheeling.

The bonding mechanism that acts upon the powdered substrate may be a focused laser beam, radiant heat from some other source, an inkjet printer dispensing a binder, or fluid dispenser supplying binder through a needle. Other bonding mechanisms include a combination of a binder and an activating agent wherein one component is printed onto the powder and the other is mixed with or coated onto grains of the powder.

A solid finished article produced by a 3D printer in the context of this invention comprises bonded particles of the powdered substrate and may include solidified binder material dispensed by an inkjet printer or another fluid dispenser. The mechanical structure of the part is provided by bonds between grains of powder that have been caused to form by the bonding mechanism. These bonds may form immediately on application, but generally they develop over a period of time, for example, by cooling of material melted by a laser beam or by dissolution, drying, and possibly polymerization or crosslinking of components of the binder material.

The surface of the finished part is defined generally by the edges of the selected regions bonded together during each machine cycle; and the interior of the part is comprised of the enclosed regions inside the edges of each bonded layer. The outer surface may have the same composition and properties and functionality as the interior, or there may be a gradient in composition or properties or functionality between the exterior and the interior of the part, depending on differences between the edges and the enclosed regions formed in each layer. Such differences may be imposed by the spreading mechanism, the bonding mechanism, or other optional mechanisms that operate upon the individual layers during the build process.

In the earlier machines developed for this technology, for example, those produced by Z Corporation (now 3D Systems) in the mid-1990's, the receiving surface of the machine comprised a horizontal rectangular platform that could be indexed vertically, and the bonding mechanism was a drop-on-demand inkjet printer that traveled in a fixed plane. The flowable powdered feed material was contained within a four-sided rectangular build box with openings on the top and bottom. As the build process progressed, the piston gradually traversed downwards in the build box and was kept full by the spreading mechanism. The four stationary walls of the build box contained the powder within the machine and provided mechanical support for the powder surface as it was bonded together into layers.

While these machines were compact and reliable, the addressable (maximum) powder receiving area was a fixed size, and it was required to fill the receiving volume (defined by the receiving area times the height of the part) with feed material whether or not that volume was fully populated with parts under construction. This led to waste of build material, and limited the size of parts these machines could construct to the envelope contained by the build box.

Other known techniques included the use of an open receiving surface with powder contained by a free-standing retaining barrier that was constructed on the 3D printer from the same material at the same time as the desired three-dimensional object. This enabled a 3D printer to construct parts with less wasted material by allowing the receiving volume to be adjusted to a margin surrounding the parts without the limiting aspects of a fixed build box. Walls could be vertical or inclined, and the further use of a dispensing mechanism that operated within an adjustable area permitted the receiving volume of the machine to be infinitely variable, with very good economy in materials.

Other techniques supplemented the 3D printed retaining barrier with a surrounding, mechanical barrier. These techniques dispense powder in the 3D object build area and between the 3D printed retaining barrier and the surrounding mechanical barrier. Certain of these techniques progressively elevate the upper surface of the mechanical barrier as layers of the object are successively built. Unfortunately, in the case of certain mechanical barriers formed from nested panels, as the upper surface is elevated, it causes void space to open up at the bottom of the barrier, which causes powder trapped between the 3D printed barrier and the outer mechanical barrier to shift and settle. This shifting and settling produces dynamic stresses on the 3D printed retaining barrier which can cause it to rupture or otherwise be damaged. Thus, a need has arisen for a method and apparatus for making three-dimensional objects by binding a powder which addresses the foregoing issues.

### BRIEF DESCRIPTION OF THE DRAWINGS

The disclosure will now be described, by way of example, with reference to the accompanying drawings, in which:

FIG. 1A is a perspective view of an apparatus for making a three-dimensional object by binding a powder wherein a vertically expandable and retractable, mechanical retaining barrier is used to retain the bindable powder within a powder receiving area during an object building process;

FIG. 1B is a cross-sectional view of the retaining barrier of FIG. 1A and a receiving surface on which a three-dimensional object is built by binding a powder;

FIG. 2A is a perspective view of the vertically expandable and retractable, mechanical retaining barrier of FIG. 1A in the fully expanded configuration;

FIG. 2B is a close-up view of the vertically expandable and retractable, mechanical retaining barrier of FIG. 2A showing interlocking connecting members;

FIG. 2C is a side elevation view of the vertically expandable and retractable, mechanical retaining barrier of FIG. 2A in a fully retracted configuration;

FIG. 2D is a side elevation view the vertically expandable and retractable, mechanical wall of FIG. 2A in a fully expanded configuration;

FIGS. 3A and 3B show cross-sectional, close-up views of a portion of the vertically expanding and retracting, mechanical retaining barrier of FIGS. 2A-2D with the upper surface of the retaining barrier at two different locations along the build axis, used to illustrate a change in trapped volume between the retaining barrier and a 3D printed barrier;

FIG. 3C shows a cross-sectioned, perspective view of a vertically expandable and retractable, mechanical retaining barrier enclosing a 3D printed retaining barrier and bindable powder;

FIG. 4A is a flowchart depicting a method of making a three-dimensional object comprising a 3D printed retaining barrier in which a percent image saturation value is reduced to adjust the rate of solidification of the 3D printed retaining barrier;

FIG. 4B is a flowchart depicting a method of making a three-dimensional object comprising a 3D printed retaining barrier in which a percent voxel saturation is reduced to adjust the rate of solidification of the 3D printed retaining barrier;

FIGS. 5A-5F are graphs depicting the rate of solidification of a 3D printed retaining barrier at varying levels of image and voxel saturation with respect to time;

FIG. 6 is a graph depicting the effect of image saturation and voxel saturation on the flexural strength of a 3D printed retaining barrier 24 hours after binder is applied to the powder;

FIG. 7 is a schematic depicting the thinning of a 3D printed retaining barrier at a location along the build axis for two different thinning geometries; and

FIGS. 8A and 8B are depictions of two different dithering patterns used to reduce the percent image saturation in a 3D printed retaining barrier.

### DETAILED DESCRIPTION

The methods and apparatuses described herein print a liquid binder into an exposed surface of a bindable powder containing an activator to form a three-dimensional object. When the binder contacts the activator, the binder polymerizes and binds powder within the printed liquid binder pattern. The printed pattern corresponds to a model of a three-dimensional object. In addition to the three-dimensional object, a 3D printed retaining barrier or wall is printed which fully or partially encloses the three-dimensional object and a volume of unbound (loose) powder surrounding the three-dimensional object.

One or both of a “percent image saturation” and a “percent voxel saturation” are adjusted to increase the rate of solidification of the 3D printed retaining barrier in the first 10 to 30 minutes after each layer of the wall is printed. Both techniques reduce the amount of binder applied to the bindable powder at the exposed surface of the powder relative to a nominal value. In the case of image saturation, the nominal value is a total surface area (in the print plane) of pixels overlapping the 3D printed retaining barrier by a threshold amount. In the case of voxel saturation, the nominal value is an amount of binder per unit volume of the powder, which may be expressed as an amount of binder per voxel or “drops per pixel”.

The term “build process” refers to the action of the 3D printer during its operation. The product of that operation is referred to by the term “build.” This includes the 3D printed component as well as loose materials, support structures, and other components that were not present when the build process was begun. As the build process progresses, material is formed in a sequence of cross-sectional portions called “layers” in a direction defined as the “build (z) axis.” The sequential increment along the build (z) axis for the formation of layers is the “object layer thickness” or “Δz.” At an intermediate point during the formation of an object layer there is a plane in space called the “dispensing plane” that coincides with the plane of action of the powder dispensing mechanism. It defines a horizontal plane below which any obstacles to the motion of the printer have no effect. Alternatively, obstacles that project above the dispensing plane may collide with the dispensing or printing mechanisms and impede the build process.

The term “receiving surface” refers to a surface on which solidifiable powder is dispensed that forms a base for the build process. It rests below the print plane from the very start of the build process, and its lateral extents are defined by the dimensional limits of the powder dispensing operation. The receiving surface may comprise a portion of the top of a static table or a portion of the upper surface of a movable pallet. A subset of the receiving surface is the “object build area” where both powder dispensing and solidification are possible. Generally, it is necessary to dispense powder outside the region through where material may be solidified; the object build area defines the portion of the receiving surface above which the build process is effected.

There exist two planes of action that step upwards during the build process. One of these is the “dispensing plane” that coincides with the upper surface of the previously printed layer. The other plane is the “print plane” that coincides with the plane formed after dispensing and leveling a layer of fresh powder on top of the dispensing plane. The printing plane is defined by a travel (x) axis along which the print engine 16 moves during an object build operation and a print (y) axis along which the printhead orifices extend during an object build operation. During the period after dispensing and leveling but before printing of the current layer, these two planes are spaced apart by one object layer thickness Δz. At all other times the two planes coincide with each other.

At any point after the start of the build process, the dispensing plane and the print plane sit at a height above the receiving surface in the build (z) axis direction. Both planes advance upwards in increments of the object layer thickness. The “receiving area” is the area on the dispensing plane where powder lands from the dispenser, and it coincides with the projection of the receiving surface onto the dispensing plane. The “receiving volume” comprises the volume of space defined by the receiving area (on the dispensing plane) projected downward to the plane of the receiving surface. This is equal to the product of physical area (in x and y) of the receiving surface times the height of the print plane (z) above the receiving surface.

The region comprising the projection of the object build area at the height of the print plane is the surface where the solidification of the 3D printed part is effected and it is therefore of prime interest in descriptions of the build process. This region is hereinafter called the “build surface.” The build surface advances upwards following the formation of any given layer as a new surface is created by the spreading mechanism.

The receiving surface generally comprises a portion of the top of a table or plate that supports the build material during the build process. The term “build table” hereinafter signifies a stationary support that may incorporate the receiving surface as a portion of its upper surface; or it may be a support for a moveable component, hereinafter described as a “build pallet” that itself may incorporate the receiving surface as a portion of its upper surface. The build table may incorporate a conveyer that facilitates motion of the receiving volume away from the machine at the completion of the build process.

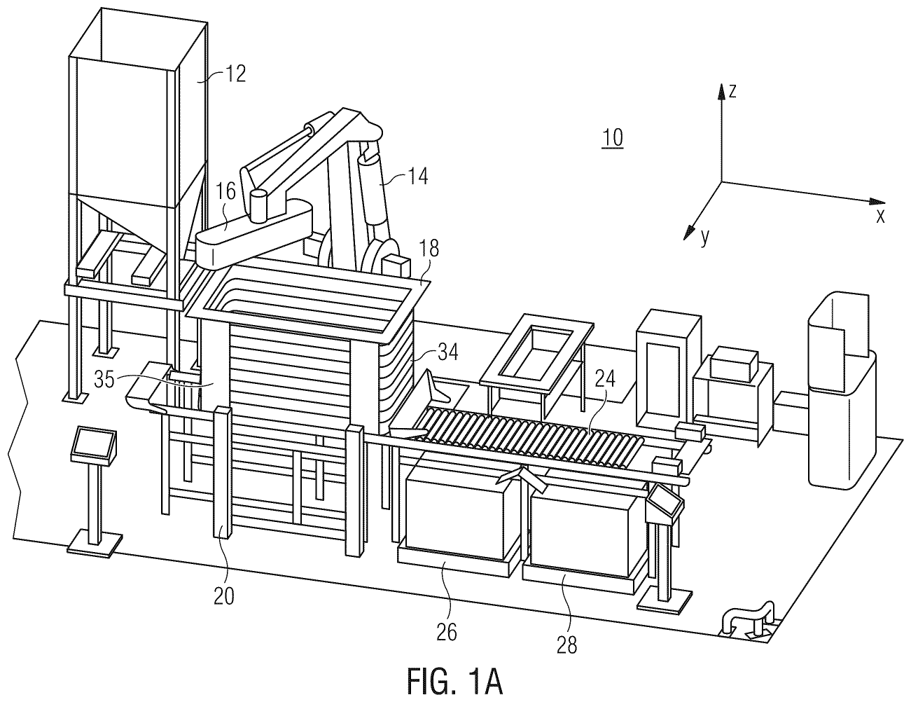

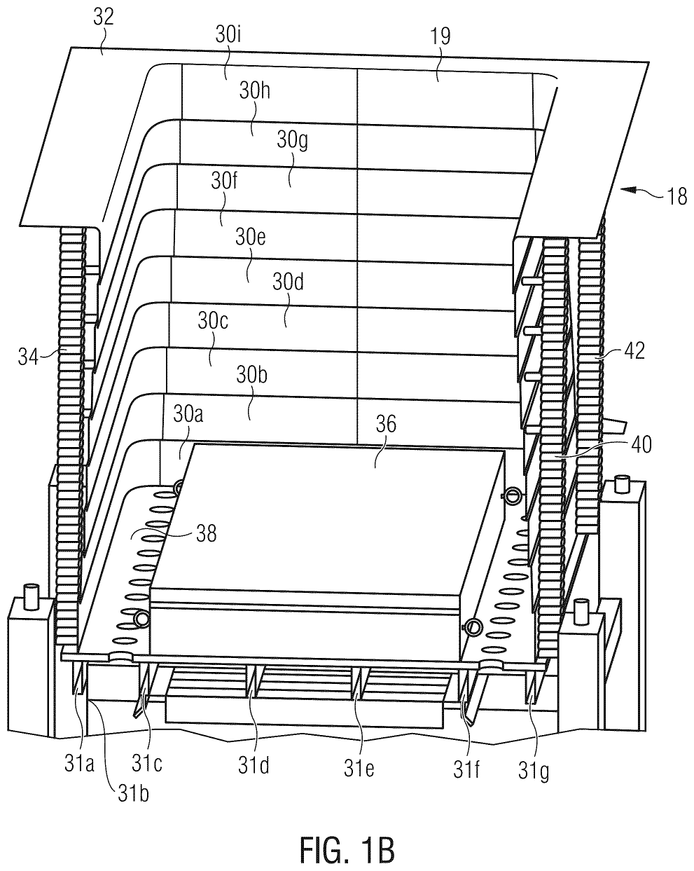

In accordance with certain examples, a 3D printer is provided which comprises a robot, a printhead, a powder dispensing and spreading mechanism, and a receiving surface. The term “printing engine” is used hereinafter to describe the combination of powder dispenser, printhead, and other devices carried by the robot over the receiving surface, as discussed further below with respect to FIG. 1A.

In examples herein, a dynamically expandable and retractable retaining barrier is provided and is dynamically expanded or extended vertically during an object building process to accommodate the receiving volume. In an embodiment, a flat build pallet serves as the receiving surface and one or more layers of powder are deposited and leveled on this surface prior to commencing the build. In a margin surrounding the active object build area, a retaining barrier such as a wall or fence may be placed to prevent an excess of powder from spilling off the edge of the pallet. The retaining barrier can be built manually by the operator, constructed by the robot, or it can be erected by another mechanism that resides outside the object build area.

In accordance with examples herein, a 3D printer based on an industrial robot incorporates a powder dispenser and a binder dispenser on the end-effector of the robot. The powder dispenser may be configured to drop and level material for the powdered substrate in a single motion, or the operations may be separated into different motions. In either case, it is desirable to contain as much as possible of the powdered substrate upon the powder receiving surface of the machine using a 3D printed retaining barrier either with or without a surrounding mechanical retaining barrier. When a 3D printed barrier is positioned within a mechanical barrier, the latter is referred to as a “primary retaining barrier,” and the former is referred to as a “second retaining barrier or “secondary retaining barrier” herein.

In accordance with certain examples, the rate of solidification of the 3D printed retaining barrier is adjusted to minimize the likelihood of the wall rupturing or becoming damaged due to stresses caused by the powder the wall retains and/or powder located between the 3D printed retaining barrier and a surrounding, mechanical retaining barrier. In one implementation, the “percent image saturation” of the 3D printed retaining barrier is reduced to less than one hundred percent.

“Percent Image saturation” refers to the percentage of an area within a print plane to which binder is applied relative to the total area of pixels or volume of voxels that define the 3D printed retaining barrier. Thus, the total area of pixels or volume of voxels that defined the 3D printed retaining barrier represent 100 percent image saturation. For a current layer of the printed retaining barrier that is being printed, the total area of pixels that define the wall is the aggregate area in the print plane of all pixels that overlap the model of the printed retaining barrier by a specified threshold, e.g., 50 percent. In the case of voxels, it is the total area of voxels in a current layer that is being printed is the total volume of the voxels that overlap the model by a specified threshold, such as 50 percent. The percent image saturation for a given layer is the percentage of

In certain examples, the percent image saturation that is used to form the layers of the 3D printed retaining barrier is no more than 70 percent, preferably no more than 65 percent, and still more preferably, no more than 60 percent. In the same or other examples, the image saturation of the layers of the 3D printed retaining barrier is no less than 40 percent, preferably, no less than 45 percent, and more preferably no less than 50 percent. The pattern in which this reduction in printed binder area is distributed may be an ordered pattern of pixels or groupings of pixels spaced apart from one another in the print plane which define a continuous web where binder is applied.

In another implementation, the rate of solidification of the 3D printed retaining barrier is increased by reducing the “percent voxel saturation.” The “percent voxel saturation” refers to a percentage of a nominal amount of binder per unit volume of bindable powder that is used to solidify the three-dimensional object. The level of binder per unit volume may be expressed as a volume of binder divided by the volume of a voxel. Alternatively, the percent voxel saturation may be expressed as percentage of a pixel's area to which binder is applied. In certain examples, the pixel dimensions along both print plane axes (x and y) are from about 200μ to about 300μ, with preferred dimensions being from about 230μ to about 270μ and more preferred dimensions being from about 250μ to about 260μ. In the same or other examples, the layer thickness along the build (z) axis is from about 100μ to about 700μ, preferably from about 200μ to about 600μ, and more preferably from about 300μ to about 500μ. The voxel volume is the product of the pixel area and the layer thickness. Thus, the voxel volume is preferably from about 0.4×10⁻⁵ cm³ to about 6.3×10⁻⁵ cm³, more preferably from about 1.1×10⁻⁵ cm³ to 4.4×10⁻⁵ cm³, and still more preferably from about about 1.9×10⁻⁵ cm³ to about 3.4×10⁻⁵ cm³.

In certain examples, the nominal volume of binder per unit of voxel volume which defines “100 percent voxel saturation” is the volume of binder per unit of voxel volume that I used to the three-dimensional object that is wholly or partially enclosed by the 3D printed retaining barrier and ranges from about 0.9 to about 2.0 percent of binder by volume of a voxel, preferably from about 0.95 to about 1.6 percent binder by volume of a voxel, and more preferably from about 1-1.5 percent binder by volume of a voxel.

The percent voxel saturation may also be expressed as the number of drops per pixel (dpp) used divided by a nominal number of drops per pixel used to make the three-dimensional object multiplied by 100. For example, if the three-dimensional object is made using eight (8) drops per pixel and the 3D printed retaining barrier 64 is made using six (6) drops per pixels, the percent voxel saturation of the printed retaining barrier pixels would be 75 percent. In examples wherein the percentage of voxel saturation is adjusted to increase the rate of solidification of a 3D printed retaining barrier while the image saturation is at 100 percent, preferred values of the percentage of voxel saturation for the wall range from about 60 percent to about 90 percent, preferably from about 70 percent to about 80 percent, and more preferably from about 73 percent to about 77 percent.

Referring to FIG. 1A, a first example of an apparatus 10 for making a three-dimensional object by selectively binding a powder is provided. The apparatus 10 forms a plurality of layers into patterns corresponding to cross-sections of the three-dimensional object being built. Apparatus 10 comprises powder hopper 12, robot 14 with a print engine 16. Robot 14 can position print engine 16 at a plurality of different x, y, and z locations with different orientations about the z-axis.

Referring to FIG. 1B, print engine 16 comprises a powder dispenser (not shown) which is in fluid communication with hopper 12 to receive powder therefrom. A plurality of powder dispensing openings extend along the length of print engine 16 and discharge powder to a receiving area. The powder may be deposited onto a receiving surface, previously deposited loose powder, and/or a previously formed object layer.

Suitable powders comprise particles that are any suitable finely divided material capable of being bonded to form an aggregate with an activated binder. The particles may be organic, inorganic, or a mixture thereof. They may be ceramic, metal, plastic, carbohydrate, small organic molecule, large organic molecule, and combinations thereof. Suitable particles include foundry sand, virgin sand, reclaimed sand, silica, quartz, zircon, olivine, magnesite, chromite, or combinations thereof.

Print engine 16 also comprises a plurality of print heads (not shown), each having a plurality of print head orifices (not visible but facing downward in FIG. 1A). During a build process, print engine 16 dispenses binder along a printing (y) axis as it travels along a travel (x) axis. In order to prevent printing gaps along the print (y) axis, the printheads are staggered along the travel (x) axis in an alternating pattern such that some of the orifices between printheads that are immediately adjacent one another along the travel (x) and print (y) axes overlap. This effectively produces two rows of printheads adjacent one another along the travel (x) axis, and the timing at which the two rows dispense binder is offset from one another so that collectively, all of the printheads can print a single line of pixels along the print (y) axis.

In one example, print engine 16 includes 16 printheads, each of which can print 256 pixels, and there is an eight (8) pixel overlap. Each printhead is configured to print a maximum of 256 pixels or voxels along the print (y) axis. The orifices of each printhead are in fluid communication with a source of a binder liquid. The binder may be any suitable material that is capable of firmly coupling adjoining particulates to each other. In a highly preferred aspect, the binder material is an organic compound, and more particularly an organic compound that includes molecules that cross-link or otherwise covalently bond among each other when activated by an acidic activator component of the bindable powder.

Apparatus 10 also includes one or more controllers (not shown) that are programmed to guide the movement and binder firing of print engine 16 and the elevation of the upper surface 32 retaining barrier 18.

In a highly preferred embodiment, the preferred material for the binder includes at least one material selected from the group consisting of phenol resin, polyisocyanate, polyurethane, epoxy resin, furan resin, polyurethane polymer, phenolic polyurethane, furfuryl alcohol, phenol-formaldehyde furfuryl alcohol, urea-formaldehyde furfuryl alcohol, formaldehyde furfuryl alcohol, peroxide, polyphenol resin, resol ester, acrylic, vinyl, styrene, other unsaturated monomers and oligomers, or mixtures thereof.

Although not visible, print engine 16 preferably includes a smoothing blade that is a is a generally rigid rectangular blade having a length parallel to print (y) axis during a build process.

The powder from hopper 12 is initially dispensed onto a receiving surface 36 (FIG. 1B) that includes an object build area. Receiving surface 36 is supported by a build table 20. As portions of the powder are solidified, subsequent volumes of powder are dispensed onto the dispensing surface (the upward facing, exposed surface of the most recently formed object layer) and in some cases, onto loose powder that has not been solidified. In certain examples, it is preferable to use robot 14 to solidify several objects, each on its own receiving surface 36. Thus, a conveyor system 24 may be provided and operatively connected to receiving surface supports 37a-37g (FIG. 1B) which move relative to build table 20. In one example, conveyor system 24 comprises a plurality rotating shafts to allow for relative movement between build surface supports 37a-37g (and hence the mechanical retaining barrier 18 and its enclosed powder) relative to hopper 12 and robot 14, and an actuation mechanism (not shown) is provided to drive the receiving surface 36 and its supports 37a-37g along the rotating shafts.

Print engine 16 is preferably operated so that prior to printing the binder, a consistent thickness of powder is provided relative to the last solidified layer, and the traversal of the smoothing blade (not shown) creates the final desired loose powder thickness before binder printing occurs. However, in the course of depositing powder and smoothing it, loose powder is deposited into the object build area which will not be used to form the three-dimensional object. Preferably some mechanism is provided to contain at least some of the loose powder so that it does not spread onto the build table 20 or past the edges of the receiving surface onto the floor. In the example of FIG. 1A, a vertically expanding and retracting, mechanical retaining barrier 18 is provided which is dynamically erected during an object building operation. Retaining barrier 18 may also be dynamically disassembled following the completion of an object building operation. The object build area (not separately shown) lies within the mechanical retaining barrier 18.

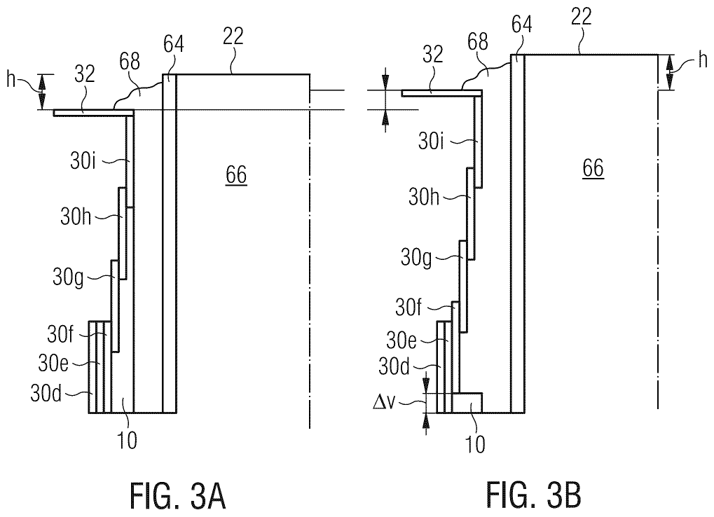

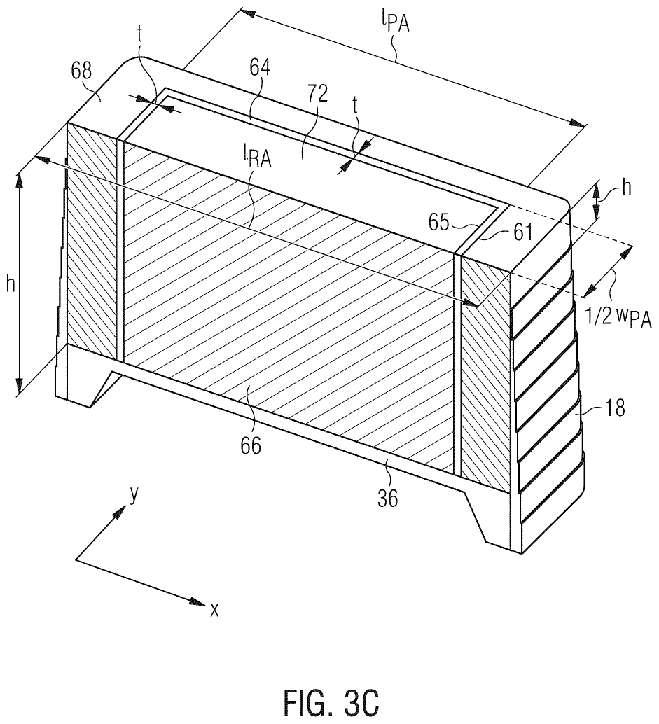

Mechanical retaining barrier 18 preferably defines a receiving area (the length of which, L_{RA} is shown in FIG. 3C) that is an area at the current dispensing plane of the printer where powder is dispensed and which is greater than the area of the object build or print area, which is the area on the receiving surface where powder solidification may occur to form a three-dimensional object and any auxiliary barriers (e.g., a 3D printed retaining barrier). The length of the print area L_{PA} is shown in FIG. 3C.

Mechanical retaining barrier 18 is preferably positioned adjacent to the object build area (and more preferably spaced apart from it by some specified margin) so as not to occupy space where the three-dimensional object will be built. However, mechanical retaining barrier 18 need not fully encircle the object build area and instead may act as a barrier that impedes the movement of powder 48 in one or more directions in the object build area.

In the examples of FIGS. 1A-3C, mechanical retaining barrier 18 comprises a telescoping fence formed of a plurality of rigid sleeves that nest together. The sleeves may be formed from sheet metal, with a set of flanges that cause each course to capture the next course in the sequence. The entire assembly may be expanded by one or more linear actuators (not shown) from below, or from a hoist from above provided the lines of support do not intersect the motion of print engine 16.

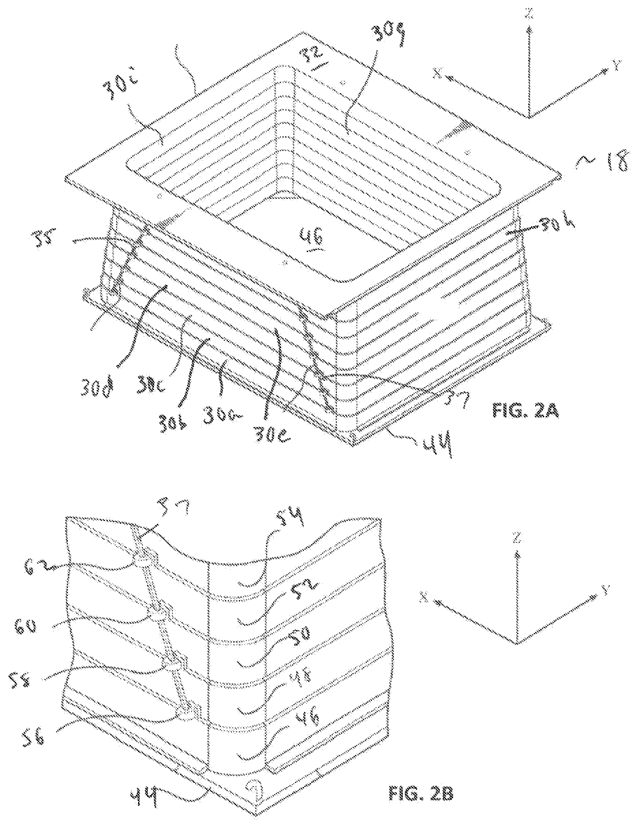

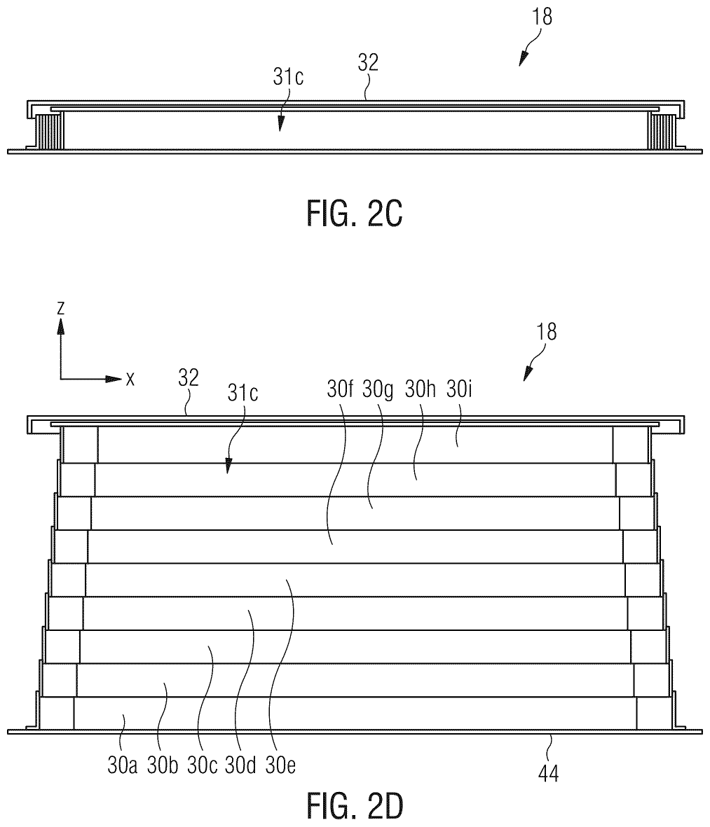

In FIG. 2C the telescoping, mechanical retaining barrier 18 is shown in a fully retracted configuration. Retaining barrier 18 is connected to and sits on an upper build plate 38 that has a plurality of openings (FIG. 1B). Upper build plate 38 sits on lower build plate (not shown). The upper build plate 38 and lower build plate are configured to allow for the selective retention and disposal of bindable powder (not shown). The build plates and the retaining barrier 18 are movable along conveyor system 24 along a conveyor travel (x) axis. conveyor system 24 allows for multiple build plate/retaining barrier assemblies to move in and out of the area of robot 14. Conveyor system 24 includes rotating shafts, and an actuator (not shown) is provided to move the build plate/retaining barrier assembly along the rotating shafts.

FIGS. 1A, 1B, 2A, and 2D show the telescoping retaining barrier 18 in a fully expanded configuration in which the upper surface 32 is at its maximum distance from upper build plate 38 along the build (z) axis. Actuators (not shown) are provided to move upper surface 32 along the build (z) axis from a retracted to expanded configuration and vice-versa. Each actuator has a corresponding shaft which is selectively extendable and retractable and which abuttingly engages a corresponding corner of upper surface 32. The telescoping retaining barrier 18 includes four sides. A three-dimensional object is built on receiving surface 36 in the interior of telescoping retaining barrier 18.

Telescoping retaining barrier 18 is positioned over receiving surface 36 at the beginning of an object build process. In the case of FIGS. 3A-C, the powder is preferably deposited on receiving surface 36 to reach a height h above the upper surface 32 of the retaining barrier 18. The height of the powder is adjusted so that when the binder printhead prints the binder liquid, the exposed surface of the object will be slightly above the upper surface 32 along the build (z) axis. Thus, the initial height of the powder is vertically spaced above upper surface 32 by a distance slightly greater than the object layer thickness Δz. This is done to ensure that the bottom of the print engine 16 smoothing blade and the binder printhead orifices are a consistent distance from the exposed powder surface 72 when solidifying each layer. As a result, however, the object will be built on a several layers of unbound powder 48.

After printing several layers of the object so that the exposed powder surface 72 (FIG. 3A-C) is above retaining barrier upper surface 32, the retaining barrier actuators are operated to elevate the retaining barrier upper surface 32 by a specified vertical height increment along the build (z) axis. The increment is preferably set so that the position of retaining barrier upper surface 32 will remain below the solidified object surface (which lies in the exposed powder surface 72 immediately after solidification and prior to the application of another powder layer). Print engine 16 traverses the receiving area (the x-y area defined by the inside of retaining barrier 18) to deposit additional powder, which is smoothed and leveled with the print engine 16 smoothing blade. As print engine 16 travels along the travel (x) axis, the binder printheads in print engine 16 print binder liquid in a series of print (y) axis patterns on the exposed powder surface 72 (FIGS. 3A-C) in a pattern corresponding to the cross-sectional profile of the three-dimensional object at the current object height along the build (z) axis. The process repeats until the object is complete.

FIG. 2C shows a side elevational view of retaining barrier 18 in a fully retracted configuration, and FIG. 2D shows a side elevational view of retaining barrier 18 in a fully expanded configuration. As best seen in FIGS. 2C and 2D and 3A-3B, the individual panels 30a-30i are “nested” so that when moving upward along the build (z) axis from the lowest panel 30a to the highest panel 30i, the panel length along the x-axis and the panel length across the y-axis decrease so that each panel can slide downward inwardly of the panel below it. As shown in FIG. 2B, corner pieces 46-54 (only five of which are shown) are located at each corner to connect adjacent sections of panels 30a-30i and are also nested in a similar fashion.

In certain examples, one or more of the sides of retaining barrier 18 include a chain or cable to keep the individual panels 30a-30i from separating from one another as the retaining barrier 18 expands in height. In the example of FIGS. 2A-2D, cables 35 and 37 are attached to connectors 56-62 (for cable 37 only) on each panel 30a-30i to connect the panels 30a-30i together. Similar connectors are provided for cable 35 and on the opposite side of the retaining barrier 18.

Receiving surface 36 may further comprise a means of transporting powder away from the receiving area 19. In an embodiment, a moveable build pallet may include a sliding gate in its surface comprising a stationary plate and a movable plate, both perforated by holes, and an actuator that causes the movable plate to shift, aligning the holes and allowing loose powder to drain through the surface of the plate. Apparatus 10 may further comprise collection devices 26 and 28 to move collected powder to a storage area for subsequent reuse, reprocessing, or disposal.

As indicated previously, the telescoping and nested nature of panels 30a-30i causes the progressive elevation of mechanical retaining barrier 18 upper surface 32 to increase the volume of unbound powder defined between mechanical retaining barrier 18 and a 3D printed retaining barrier 64. The 3D printed retaining barrier 64 partially or wholly encloses the 3D object being built. In FIG. 3C, which is a perspective view of a cross-section in the x-z plane, the 3D printed retaining barrier 64 fully encloses the three-dimensional object and has an inner boundary 65 and an outer boundary 67 which are spaced apart by the thickness of 3D printed retaining barrier 64. The 3D printed retaining barrier 54 has an inner boundary 65 and an outer boundary 67 (FIG. 3C).

FIGS. 3A and 3B show retaining barrier 18 with upper surface 32 at two different build (z) axis positions. At periodic intervals during the build process, upper surface 32 of retaining barrier 18 is elevated relative to receiving surface 36 along the build (z) axis. As the upper surface 32 is pulled or pushed upward, panel 30f rises by an amount indicated as “new” in FIG. 3B. The movement of the lower panel increases the volume defined between the retaining barrier 18 and printed retaining barrier 64, and initially creates a void space at the bottom of the retaining barrier 18, causing powder to flow into the void space. The movement of powder may not happen continuously and smoothly, but rather, may happen suddenly and cause the powder surrounding the 3D retaining barrier 64 to apply dynamic forces against the 3D printed retaining barrier 64. These dynamic forces may be significant and may damage the printed retaining barrier 64, which may in turn damage the three-dimensional object being built.

In order to reduce the likelihood of damaging the 3D printed retaining barrier 64, it is desirable to increase the rate of solidification of the bindable powder used to form it so that the 3D printed retaining barrier 64 can withstand the dynamic powder forces resulting from the shifting of unbound bindable powder produced by the upward movement of the upper surface 32 of retaining barrier 18. It has been unexpectedly determined that by reducing the amount of binder applied to each layer of powder, during a period ranging from 0 to at least 10 minutes, preferably from 0 to at least 15 minutes, and more preferably from 0 to at least 20 minutes, the rate of solidification of a layer and the rate at which the strength of the solidified layers increases following the application of binder may be increased even though the ultimate strength of the layers may be lower than they would otherwise be had the amount of binder not been reduced. As explained previously, two such techniques are reducing the percent image saturation and reducing the percent voxel or pixel saturation for each layer.

A method of making a three-dimensional printed retaining barrier in the course of making a three-dimensional object from a bindable powder will now be described. The method is preferably embodied in a set of computer executable instructions stored on a non-transitory computer readable medium and executed by a processor within a controller that is operatively connected to print engine 16 such that it can move print engine 16 along the travel (x) axis, fire the binder along the print (y) axis, and elevate the upper surface 32 of mechanical retaining barrier 18.

In general, it is preferable to minimize the x-y area of the 3D printed retaining barrier 64 to decrease the amount of unbound powder lying within it. At the conclusion of the build process, the 3D printed retaining wall 64 must be broken up to remove the enclosed three-dimensional object, and any powder lying within the 3D printed retaining wall is more likely to be contaminated with solid parts of the 3D printed retaining barrier, which can make it difficult to reuse that powder. It is also generally desirable to minimize the overall volume of the 3D printed barrier 64. Referring to FIG. 3C, the volume of 3D printed barrier 64 is the product of the length of the print area (LPA), the width of the print area WPA, the thickness t, and the build axis height h. multiplied by the (i.e., the sum of the products of the lengths of each side and the thickness of the barrier 64), and the powder used to form the 3D printed retaining barrier 64 is basically unrecoverable. The 3D printed barrier 64 should be strong enough to withstand the forces applied to it during the build process without rupturing or otherwise being compromised.

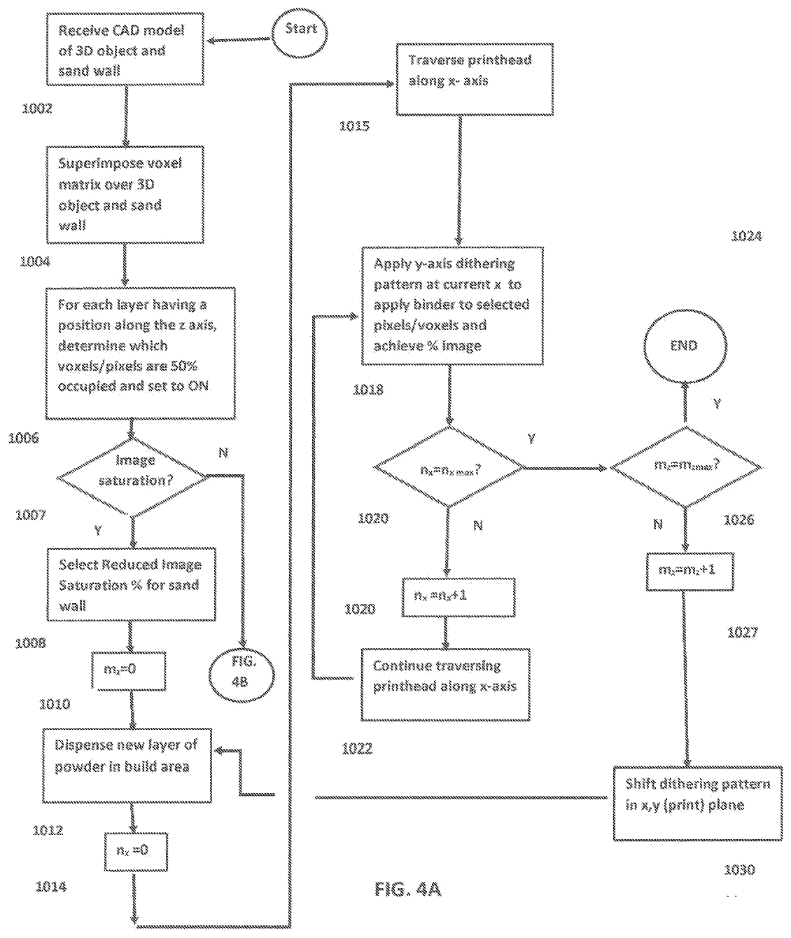

Referring to FIG. 4A, in accordance with one method of making a three-dimensional object, in step 1002 a CAD model of the object and the 3D printed retaining barrier 64 is received. In certain examples, the 3D printed retaining barrier 64 may be sized for each particular build process. However, in other examples, the same barrier 64 dimensions are used for all object builds. In certain examples, 3D printed barrier 64 has a thickness of from about 10 mm to about 30 mm, preferably from about 15 mm to about 25 mm, and more preferably from about 18 mm to about 22 mm. In the same or other examples, the 3D printed retaining wall 64 has a length ranging from about 1600 mm to about 2100 mm, preferably from about 1700 m to about 2000 mm, and more preferably from about 1800 mm to about 1900 mm. In the same or other examples, the 3D printed retaining wall 64 has a width ranging from about 600 mm to about 1100 mm, preferably from about 700 mm to about 1000 mm and more preferably from about 800 mm to about 900 mm.

In step 1004 a voxel matrix is mathematically superimposed over the CAD model of the object and the 3D printed retaining barrier 64. In step 1006 the overlap between the object defined by the CAD model and 3D printed retaining barrier 64 and the voxels is determined, and any voxel exceeding a particular threshold degree of overlap (e.g., 50 percent) is set to ON (or any other suitable binary state indicator), meaning that binder will be applied to it. No binder is applied to voxels not having the threshold degree of overlap, i.e., those voxels are set to OFF. Step 1006.

The voxels or pixels for each layer of the object and the 3D printed retaining barrier 64 comprise a plurality of print data sets that can be visualized as strips with a length along the print (y) axis, wherein each strip corresponds to travel (x) axis location. The number of strips depends on the frequency with which the binder firing pattern can be changed as the print engine 16 travels along the travel (x) axis. In preferred examples, the print engine 16 moves and fires such that it creates pixel or voxel patterns that are substantially perpendicular to the direction of travel of print engine 16 along the travel (x) axis.

In step 1007 the method determines if reducing the percentage of image saturation has been selected as a means for increasing the rate of solidification of the 3D printed retaining barrier 64. If it has not, control transfers to FIG. 4B to reduce the percentage of voxel saturation to achieve faster solidification rates. If step 1006 returns a value of YES, control transfers to step 1008, and a desired percentage of image saturation is selected. In certain examples, the percent image saturation of the layers of the 3D printed retaining barrier is no more than 70 percent, preferably no more than 65 percent, and still more preferably, no more than 60 percent. In the same or other examples, the image saturation of the layers of the 3D printed retaining barrier is no less than 40 percent, preferably, no less than 45 percent, and more preferably no less than 50 percent. In step 1010 a layer index m_{z} is initialized to a value of zero, and a new layer of bindable powder is dispensed and leveled in the build area (step 1012).

As explained previously, the data used to drive the firing of the binder in print engine 16 is divided into data sets of print (y) axis voxels or pixels, wherein each data set has a travel (x) axis index and location associated with it. Thus, in the method of FIG. 4A, a travel (x) axis index nₓ is incremented at each travel (x) axis location at which the binder firing pattern may be changed.

In step 1014 the travel axis index nₓ is initialized to a value of zero. The print engine 16 traverses the exposed surface 72 of bindable powder (step 1015) to apply binder to the powder. The powder may have been added in a prior traverse or maybe added if the print engine 16 is configured for concurrent powder distribution and binder printing.

In step 1018 binder is applied in along the print (y) axis such that for those print (y) axis locations at which the 3D printed retaining barrier 64 is to be printed, the percentage of pixels or voxels across the entire layer to which binder is applied relative to those set to ON based on the overlap of the voxel matrix (or pixels if processing is done in flat layers) equals the percentage image saturation selected in step 1008. In certain examples, the reduction in the percentage of image saturation is carried out by using a “dithering pattern” for the layer which achieves the desired reduction in active voxels or pixels receiving the binder. Suitable dithering patterns may be readily selected by those skilled in the art. In preferred examples, the same dithering pattern is used for each layer of the 3D printed barrier 64 but the pattern is pixel shifted to produce better inter-layer adhesion. At any one travel (x) axis location, the pixels/voxels for the 3D printed retaining wall 64 along the print (y) axis may, as a set, have a percent image saturation that is above or below the value selected in step 1008 as long as all of the voxels/pixels in each layer for the entire 3D printed retaining barrier 64 are printed in accordance with the selected value and the selected dithering pattern. Those pixels/voxels located where the three-dimensional object is printed stay at 100 percent image saturation in step 1006.

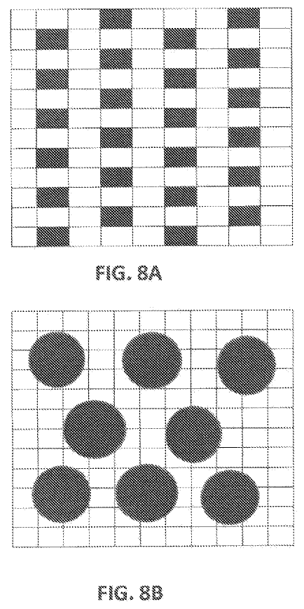

In a first kind of dithering pattern (FIG. 8A), the voxels/pixels are ordered in a dithered pattern in the print (x-y) plane. The blackened pixels are those that are overlapped by the model of the 3D printed retaining barrier but which are turned OFF (no binder is applied) to achieve the desired percent image saturation. In another kind of dithering pattern (FIG. 8B), a continuous web is created in which there are groupings of pixels/voxels that are turned OFF (shown in black) even though they overlap the model of the 3D printed retaining barrier 64. In reality the black circles would not be perfectly circular as any one pixel must either be fully on or fully off, but circles are used for case of illustration.

In step 1020 the travel (x) axis index nₓ is compared to the maximum index value nₓₘₐₓ to determine if the layer has been completed. If not, control transfers to step 1020, wherein the travel (x) axis index nₓ is incremented by one and binder is applied using the data set for the next travel (x) axis index value. If the layer is complete (step 1020 returns a value of YES), control transfers to step 1026 to determine if the build is complete, in which case the build index m_{z} will have reached its maximum value of m_{zmax}. If the layer is complete, the method ends. Otherwise, in step 1027, the layer index m_{z} is incremented by one. In step 1030, the dithering pattern for the 3D printed retaining wall 64 is shifted in the x, y plane by a selected number of pixels or voxels, and control transfers to step 1014 to begin solidifying the new layer of powder in accordance with object build data and dithered 3D printed retaining wall 64 data. Although not separately shown at periodic intervals, the upper surface 32 of mechanical retaining barrier 18 is elevated to a level that is no higher than the print plane. The frequency of elevating the upper surface 32 and the distance by which it is elevated will depend on the sensitivity of the actuation system and the configuration of the mechanical retaining wall 18, both of which will affect the minimum distance that the upper surface 32 can be elevated along the build (z) axis at any one time.

As mentioned previously, in certain examples the percentage of voxel saturation may be reduced to increase the rate of solidification of the 3D printed retaining wall 64. In certain examples, the percent image saturation for the 3D printed retaining barrier 64 remains at 100 percent when this method is used, although both variables can also be varied.

If step 1007 returns a value of NO, the percent voxel saturation is used to increase the initial rate of solidification of the 3D printed retaining barrier 64 (i.e., the rate of solidification in the first 10 minutes after printing, preferably in the first 20 minutes, and more preferably in the first 30 minutes), and control transfers to step 1032 and a desired percentage of voxel saturation is selected, preferred values of which were described previously. At one hundred percent image saturation (which is used to make the 3D object, but not the 3D printed retaining barrier, the amount of binder per unit volume is preferably selected to achieve a desired a value of flexural strength 24 hours after the part is completed of from about one (1) to about three (3) MPa, preferably from about 1.5 to about 2.5 MPa and even more preferably from about 1.8 to about 2.2 MPa.

The flexural strength values are three-point bend test values determined in accordance with ASTM D-790 using a rectangular bar formed from the same bindable powder and binder but with the test specimen dimensions being one inch by one inch by eight inches. The test specimen is placed on two bars oriented along the length of the specimen and a substantially identical bar placed on the opposite side of the specimen midway between the lengthwise position of the other two bars on which the specimen rests. A downward load perpendicular to the test specimen is applied to the center bar which is sufficient to displace the center bar downward it at a rate of 13 mm/min, and the peak load at specimen breakage is the measured flexural strength. In certain examples, the 100 percent voxel saturation value corresponds to a dispensed binder volume of from about 0.9 to about 2.0 percent volume of binder by volume of a voxel, preferably from about 0.95 to about 1.6 percent volume of binder by volume of a voxel, and more preferably from about 1-1.5 percent binder by volume of a voxel. In examples wherein the percentage of voxel saturation is adjusted to increase the rate of solidification of a 3D printed retaining barrier while the image saturation is at 100 percent, preferred values of the percentage of voxel saturation for the 3D printed retaining barrier 64 range selected in step 1032 range from about 60 percent to about 90 percent, preferably from about 70 percent to about 80 percent, and more preferably from about 73 percent to about 77 percent.

In step 1034 the layer index mx is initialized to a value of zero. A new layer of powder is dispensed and leveled in step 1036. In step 1038, the travel (x) axis index nₓ is initialized to a value of zero. Traversal of print engine 16 along the travel (x) axis begins in step 1040. In step 1042 binder is applied to the powder. In those print (y) axis regions in which the three-dimensional object is located, a 100 percent voxel saturation is used. In those locations where 3D printed retaining barrier 64 is located, the percentage of voxel saturation selected in step 1032 is used. The value of the travel (x) axis index nₓ is checked in step 1044 to determine if the layer has been completed. If it has not, the index is incremented by one in step 1046, and the print engine 16 continues to traverse the travel (x) axis (step 1048) and apply binder (step 1042).

If the layer is complete, step 1044 returns a value of YES, and control transfers to step 1052. In step 1052 the current value of the layer index m_{z} is compared to the maximum number of layers for the build m_{zmax}. If the current index has reached the maximum value, step 1052 returns a value of YES, and the build ends. If the current index has not reached the maximum value, step 1052 returns a value of NO, and the layer index is incremented by one (step 1054). A new layer of powder is applied (step 1036) and the next layer is solidified.

Although FIGS. 4A and 4B use either the percentage image saturation or the percentage of voxel saturation to increase the rate of solidification of 3D printed retaining barrier 64, both variables can be manipulated.

### Examples

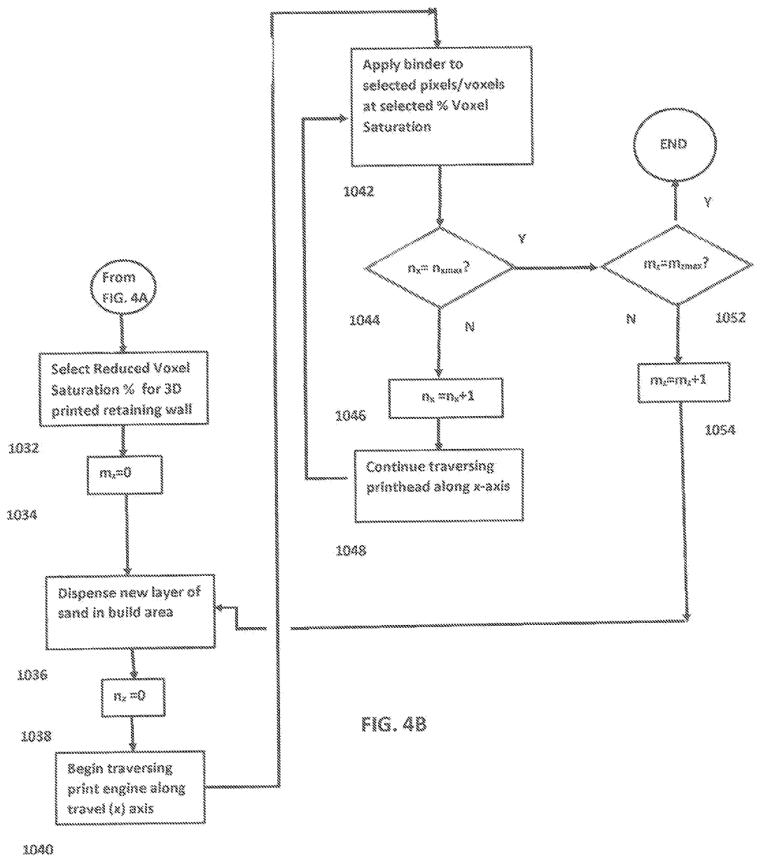

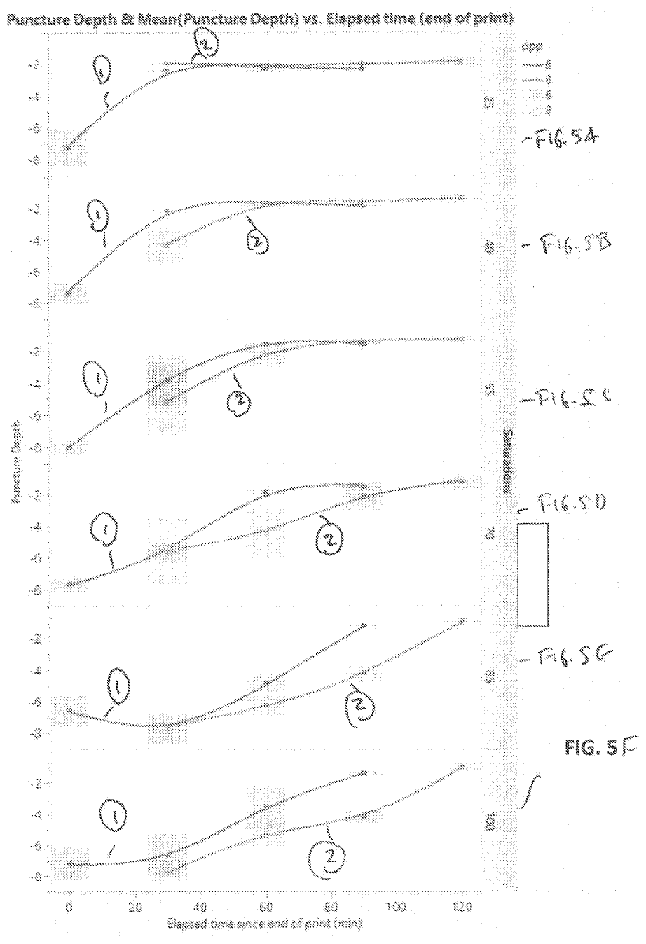

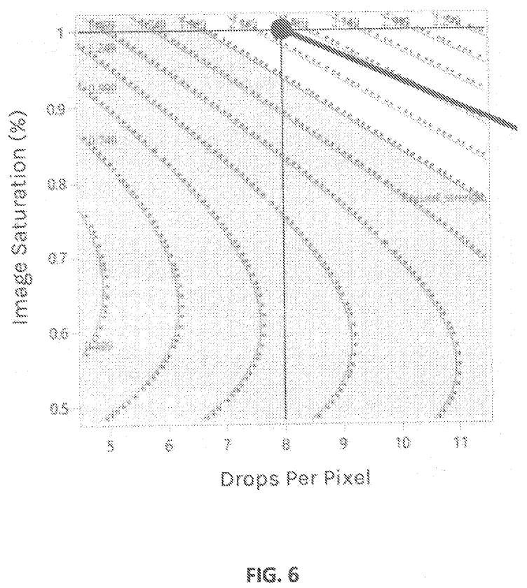

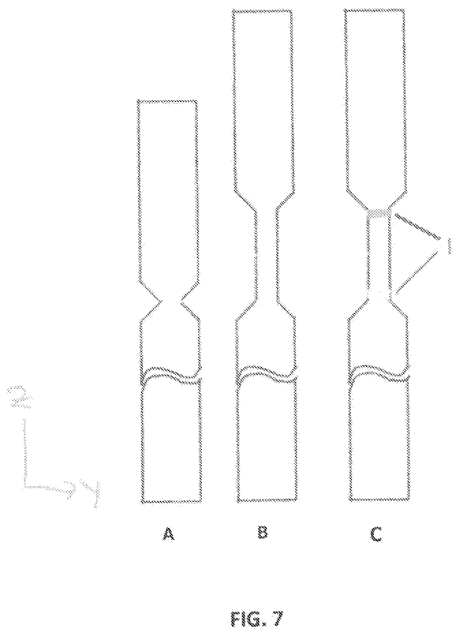

FIGS. 5A to 6F illustrate solidification rate data for a specimen prepared using the techniques described herein. Puncture depth measurements of the specimen were taken at various time intervals following the printing of the last layer of the specimen. The y-axis values are puncture depths measured from the surface of the specimen. The values are negative because the force was applied downward relative to the earth. Thus, a value of −8 indicates a deeper depth of penetration than a value of −2, i.e., higher absolute values on the y-axis correspond to deeper penetration, and hence, a lesser degree of solidification.

The puncture depth test used is a hybrid of the ASTM Shore A and Shore C hardness tests. A sharp tipped probe with a tip angle of approximately 60 degrees is applied to a surface of the specimen with a force ranging from 1-5 Newtons. The depth of penetration is an indication of the degree of solidification of the part. The curves labeled with a “1” are those for which the binder amount used is six drops per pixel, and the curves labeled with a “2” are those for which the binder amount used is eight drops per pixel. Thus, the “1” curves have a lower percentage of voxel saturation than the “2” curves. The percentage of image saturation used varies between the various figures, with values ranging from 25 percent (FIG. 5A) to 100 percent (FIG. 5F). As the figures indicate, at percentage image saturation values of 70 and lower, the puncture depth values are asymptotic at a puncture dept of about −2. In contrast, the penetration depths for 55 and 100 percent image saturation are not asymptotic, indicating that the (absolute value of the) final penetration depth several hours after completion of the build could be much lower (shallower). However, the curves for 25-55 percent image saturation show significantly faster solidification in the first 20 minutes of build. As a result, at 55 percent image saturation, 3D printed retaining barrier 64 is less vulnerable to damage or rupture early in the build.

Surprisingly, the concavity of the “1” curve changes at 75 percent image saturation relative to 50 percent image saturation, which corresponds to a significant decrease in the rate of solidification. As a result, higher percent image saturation values unexpectedly increase the 3D printed retaining barrier's vulnerability to rupture or collapse 20 minutes after solidification. Because the 3D printed retaining barrier 64 is ultimately removed when the part is complete, the increased rate of initial solidification of the printed retaining barrier 64 is more important than its ultimate strength in terms of reliably retaining enclosed powder while producing three-dimensional objects. Thus, FIGS. 5A-5F demonstrate the unexpected result that reducing the area to which binder is applied relative to the area dictated by the voxelized model of the wall increases the rate at which each layer of the wall solidifies, at least early in the build.

FIG. 6 is a plot of the flexural strength as a function of percent image saturation and voxel saturation (expressed as drops per pixel, with 8 dpp being used for the three-dimensional object and representing 100 percent voxel saturation) 24 hours after a test specimen is built. In FIG. 6 the contours are lines of constant flexural strength. As indicated previously, preferred flexural strengths for three-dimensional objects 24 hours after completion of a build are from about one (1) to about three (3) MPa, preferably from about 1.5 to about 2.5 MPa and even more preferably from about 1.8 to about 2.2 MPa. The large circle at 100 percent image saturation and eight drops per pixel lies on the contour for a flexural strength of about 2.38 MPa. The shaded area lies beneath a flexural strength of 2 MPa, which in some examples is a minimum desired flexural strength at 24 hours. Thus, at 8 drops per pixel, percent image saturation values of 60 to 80 percent yield flex strengths that are far too low for the three-dimensional object. However, owing to the increased rate of solidification and the fact that the 3D printed retaining barrier is ultimately removed, they yield unexpectedly beneficial results in terms of allowing the 3D printed retaining barrier to survive the entire build process, especially in situations where an external mechanical wall produces fluctuations in the powder volume between the external wall and the 3D printed retaining barrier.

In accordance with certain examples, 3D printed retaining barrier 64 is designed to facilitate its removal after a build is complete. In accordance with such examples, printed retaining barrier 64 is preferably thinned at several spaced apart locations along the height (2) axis to provide regions where the printed retaining barrier 64 can be more easily broken for removal of the three-dimensional object. Referring to FIG. 7, a selected portion of each of three different 3D printed retaining barriers 64 is shown. In each case, there is a position along the height (z) axis where the wall's dimension along the print (y) axis is thinner than at other locations along the height (2) axis. In preferred examples using a rectangular 3D printed retaining barrier 64, the wall thickness along one of the travel (x) or print (y) axis is thinned, and the thinned section extends along the other of the travel (x) or print (y) axis. In FIG. 7, the three sections are cross-sectional views of the portion of the 3D printed retaining barrier 64 that extends along the travel (x) axis. Thus, along the side of the wall that extends along the travel (x) axis, the wall thickness along the print (y) axis will be thinned at certain locations along the height (z) axis, and the thinned sections will preferably extend along the entirety of or substantially the entirety of the travel (x) axis. Conversely, along the side of the printed retaining barrier 64 that extends along the print (y) axis, the wall thickness along the travel (x) axis will be thinned at certain locations along the height (z) axis, and the thinned sections will preferably extend along the entirety of or substantially the entirety of the print (y) axis. A variety of different thinning geometries may be used. In FIG. 7, the (a) and (b) cross-sections show two possible geometries. In cross-section (a), a prism like groove extends along the travel (x) axis, and the thickness of printed retaining barrier 64 along the prism-like groove is reduced along the print (y) axis relative to the other height (z) axis locations shown in the cross-section. In cross-section (b), a thinned planar section is created with sloping walls. This geometry creates two height (z) axis locations of increased stress concentration extending along the travel (x) axis. The thinned geometries allow the printed retaining barrier 64 to be removed without the same degree of destructive force (e.g., from hammering or chiseling) which reduces the likelihood of solidified portions of the printed retaining barrier 64 becoming entrained in the loose powder, which in turn makes the loose powder easier to recycle and reuse.

What is claimed is:

1. An apparatus for making a three-dimensional object along a build axis, comprising:
a powder dispenser operable to dispense powder within a dispensing plane to define a print plane while moving over the dispensing plane;
at least one printhead operable to print a liquid binder onto the powder within the print plane while moving over the print plane;
a receiving surface comprising an object build area;
an extendable first retaining barrier that at least partially encloses the object build area, wherein the extendable first retaining barrier has a top surface that is extendable along the build axis away from the receiving surface;
an actuator operable to extend the extendable first retaining barrier to a plurality of positions along the build axis; and
a controller programmed to (i) receive second retaining barrier data comprising a plurality of print data sets, wherein each print data set corresponds to a position along the build axis and defines locations in the print plane where the second retaining barrier is to be formed, the locations in the print plane where the second retaining barrier is to be formed defining inner and outer boundaries of the second retaining barrier and a total second retaining barrier area in the print plane, and (ii) cause the at least one printhead to print the liquid binder onto the powder in the print plane and between the inner and outer boundaries over a reduced second retaining barrier area in the print plane which is less than the total second retaining barrier area.

2. The apparatus of claim 1, wherein the reduced second retaining barrier area is no less than 40 percent of the total area.

3. An apparatus according to claim 1, wherein the reduced second retaining barrier area is no greater than 70 percent of the total second retaining barrier area.

4. The apparatus of claim 1, wherein each print data set comprises a set of pixels, each set of pixels at each build axis position occupies the total second retaining barrier area in the print plane, each pixel in each set of pixels corresponds to a location in the print plane at which the second retaining barrier is to be formed, and wherein the controller is programmed to cause the at least one printhead to print liquid binder onto the powder for a set of fewer than all of the pixels in each set of pixels.

5. The apparatus of claim 1, wherein each print data set comprises a set of voxels, each set of voxels at each build axis position occupies the total second retaining barrier area in the print plane, each voxel in each set of voxels corresponds to a location in the print plane at which the second retaining barrier is to be formed, and wherein the controller is programmed to cause the at least one printhead to print liquid binder onto the powder for a set of fewer than all of the voxels in each set of voxels.

6. The apparatus of claim 4, wherein the set of fewer than all of the pixels is no more than 40 percent of all the pixels in each set of pixels.

7. An apparatus according to claim 4, wherein the set of fewer than all of the pixels is no greater than 70 percent of all of the pixels in each set of pixels.

8. An apparatus according to claim 5, wherein the set of fewer than all of the voxels is no more than 40 percent of all the voxels.

9. An apparatus according to claim 5, wherein the set of fewer than all of the voxels is no more than 70 percent of all of the voxels.

10. The apparatus of claim 1, wherein the controller is programmed to print the liquid binder onto the powder at locations in the print plane at which the three-dimensional object is to be formed at a first percentage of binder liquid volume per unit volume of the powder and is further programmed to print the liquid binder onto the powder the locations in the print plane at which the second retaining barrier is to be formed at a second percentage of binder liquid per unit volume of the powder, and the second percentage is les than the first percentage per unit volume of the powder.

11. The apparatus of claim 10, wherein the unit volume of the powder is a voxel volume ranging from about 0.4×10⁻⁵ cm³ to about 6.3×10⁻⁵ cm³.

12. The apparatus of claim 11, wherein the first percentage of binder liquid volume per voxel volume is from about one to about 1.5 percent.

13. An apparatus according to claim 11, wherein the second percentage of binder liquid per voxel volume is less than one percent.

14. An apparatus according to claim 1, wherein at one or more build (z) axis locations the secondary retaining barrier has a reduced thickness extending along one selected from the travel axis and the print axis.

15. The apparatus of claim 1, wherein the primary retaining barrier does not comprise the powder.

16. The apparatus of claim 1, wherein the extendable first retaining barrier surrounds the object build area.

17. The apparatus of claim 1, wherein the extendable first retaining barrier comprises a set of hinged panels.

18. The apparatus of claim 1, wherein the extendable first retaining barrier comprises a plurality of rigid, nested sleeves or panels that define a telescoping fence.

19. An apparatus for making a three-dimensional object, comprising:
a powder dispenser operable to dispense powder within a dispensing plane to define a print plane while moving over the dispensing plane, wherein the powder dispenser is also movable along a build axis perpendicular to the dispensing plane;
at least one printhead operable to print a liquid binder onto the powder within the print plane while moving over the print plane, wherein the printhead is movable along the build axis;
a receiving surface defining an object build area;
an extendable first retaining barrier that at least partially encloses an object build area in a direction parallel to the dispensing plane, wherein the extendable first retaining barrier has a top surface that is extendable along the build axis away from the receiving surface;
an actuator operable to extend the extendable first retaining barrier to a plurality of positions along the build axis; and
a controller programmed to (i) receive a plurality of three-dimensional object voxel data sets, wherein each three-dimensional object voxel data set comprises a plurality of three-dimensional object voxels and corresponds to a location in the print plane and along the build axis where the three-dimensional object is to be formed, (ii) print a first volume of binder per voxel into the powder at each three-dimensional object voxel; and (iii) receive a plurality of second retaining barrier data sets, wherein each second retaining barrier data set comprises a plurality of second retaining barrier voxels and corresponds to a location in the print plane and along the build axis where the second retaining barrier is to be formed, and (iv) cause the at least one printhead to print a second volume of liquid binder per voxel into the powder at at least some of the second retaining barrier voxels at a second volume of binder per voxel, wherein the second volume of binder per voxel is less than the first volume of binder per voxel.

20. The apparatus of claim 19, wherein the second volume of liquid binder per voxel is not more than 90 percent of the first volume of liquid binder per voxel.

21. The apparatus of claim 19, wherein the controller is programmed to cause the at least one printhead to print the liquid binder into the powder at no more than 60 percent of the second retaining barrier voxels.
